(19) United States
(12) Patent Application Publication
(10) Pub. No.: US 2014/0045077 A1
(43) Pub. Date: Feb. 13, 2014

(54) NON-AQUEOUS ELECTROLYTE SECONDARY BATTERY

(71) Applicant: Sanyo Electric Co., Ltd., Moriguchi City (JP)

(72) Inventors: Keisuke Minami, Kanzaki-gun (JP); Toyoki Fujihara, Kanzaki-gun (JP); Toshiyuki Nohma, Kobe City (JP)

(21) Appl. No.: 13/943,076

(22) Filed: Jul. 16, 2013

(30) Foreign Application Priority Data
Aug. 9, 2012 (JP) 2012-177189

(51) Int. Cl. H01M 10/056

(52) U.S. Cl. CPC H01M 10/056
USPC 429/338

(57) ABSTRACT

To provide a high-capacity non-aqueous electrolyte secondary battery having superior cycle properties and safety.

The present invention is a non-aqueous electrolyte secondary battery including electrode cores and a non-aqueous electrolyte containing a non-aqueous solvent, the positive electrode having a positive electrode active material layer formed on the positive electrode core, and the negative electrode having a negative electrode active material layer formed on the negative electrode core. In this non-aqueous electrolyte secondary battery, the non-aqueous solvent includes 25 to 40 vol % ethylene carbonate at 25° C. and 1 atm, the non-aqueous electrolyte includes lithium bis(oxalato)borate, the amount of positive electrode active material in the positive electrode active material layer is equal to or greater than 100 g, the amount of negative electrode active material in the negative electrode active material layer is equal to or greater than 50 g, and the battery capacity of the non-aqueous electrolyte secondary battery is equal to or greater than 15 Ah.

### CROSS-REFERENCE TO RELATED APPLICATIONS

This application claims the benefit of Japanese Patent Application No. 2012-177189 filed Aug. 9, 2012, the disclosure of which is herein incorporated by reference in its entirety.

### FIELD OF THE INVENTION

The present invention relates to a non-aqueous electrolyte secondary battery and, more specifically, to an improvement in the battery characteristics of a non-aqueous electrolyte secondary battery.

### BACKGROUND

Battery-powered vehicles with a secondary battery power supply, such as electric vehicles (EV) and hybrid electric vehicles (HEV), are becoming increasingly popular. However, these battery-powered vehicles require high-output/high-capacity secondary batteries.

Non-aqueous electrolyte secondary batteries, such as lithium ion secondary batteries, have a high energy density and a high capacity. The positive electrode and negative electrode have an active material layer provided on both sides of the electrode core, and the positive electrode and negative electrode are wound together or laminated on each other via a separator to form an electrode assembly. This electrode assembly increases the opposing surface area between the positive and negative electrodes, and facilitates the extraction of a large current. As a result, non-aqueous electrolyte secondary batteries using a wound or laminated electrode assembly are used for this purpose.

In Patent Document 1, a technology related to a collector structure for stably extracting current from a high-output battery has been proposed.

### PRIOR ART DOCUMENTS

### Patent Documents

Patent Document 1 Published Unexamined Patent Application No. 2010-086780.

The technology disclosed in Patent Document 1 is a rectangular secondary battery having a first electrode core and a second electrode core on both ends in which a first current collecting plate is arranged in a first electrode core collecting area from which first electrode cores laminated directly on top of each other protrude. The first current collecting plate is resistance-welded on a surface parallel to the plane on which the first electrode cores are laminated. In this secondary battery, a first electrode core melt-attachment portion to which the first electrode cores are melt-attached is formed in an area separate from the area in which the first current collecting plate is attached.

### SUMMARY

### Problem Solved by the Invention

In addition to a better collector structure, vehicle-mounted batteries also require improved output characteristics as well as improved durability, such as storage characteristics and cycle characteristics. However, these points are not considered in Patent Document 1.

In view of this situation, an object of the present invention is to provide a high-capacity non-aqueous electrolyte secondary battery having superior safety and cycle properties.

### Means of Solving the Problem

In order to solve this problem, the present invention is a non-aqueous electrolyte secondary battery including a positive electrode, a negative electrode and a non-aqueous electrolyte containing a non-aqueous solvent. The positive electrode has a positive electrode core and a positive electrode active material layer formed on the positive electrode core, the negative electrode has a negative electrode core and a negative electrode active material layer formed on the negative electrode core, the non-aqueous solvent includes 25 to 40 vol % ethylene carbonate at 25° C. and 1 atm, the non-aqueous electrolyte includes lithium bis(oxalato)borate (LiB(C₂O₄)₂), the amount of positive electrode active material in the positive electrode active material layer is equal to or greater than 100 g, the amount of negative electrode active material in the negative electrode active material layer is equal to or greater than 50 g, and the battery capacity of the non-aqueous electrolyte secondary battery is equal to or greater than 15 Ah.

In this configuration, the non-aqueous solvent contains 25 vol % or more ethylene carbonate. This improves cycle characteristics and discharge characteristics such as output characteristics. The non-aqueous electrolyte also contains lithium bis(oxalato)borate. This improves the cycle characteristics.

However, a non-aqueous electrolyte containing lithium bis(oxalato)borate readily reacts with the negative electrode and generates heat under high-temperature charging conditions. The generated heat tends to increase as the amount of ethylene carbonate in the non-aqueous electrolyte and the amount of positive electrode active material rise (high-capacity). In the present invention, the amount of positive electrode active material is 100 g or more, the amount of negative electrode active material is 50 g or more and the battery capacity is 15 Ah or more. In this high-capacity battery, the amount of ethylene carbonate is kept to 40 vol % or less in order to reduce the amount of heat generated by the non-aqueous electrolyte containing lithium bis(oxalato)borate. This can increase the cycle characteristics without adversely affecting safety.

When the non-aqueous electrolyte contains too little lithium bis(oxalato)borate, the effect is insufficient. When too much lithium bis(oxalato)borate is added, the upper limit on effectiveness is exceeded and the additional amount is not cost effective. Therefore, the amount of lithium bis(oxalato)borate added is preferably from 0.06 to 0.18 mol/L.

In the present invention, the battery capacity is the discharge capacity (initial capacity) when the battery has been charged to a battery voltage of 4.1 V using 1 It of constant current, charged for 1.5 hours at a constant voltage of 4.1 V, and then discharged after charging to a battery voltage of 2.5 V at a constant current of 1 It. The charging and discharging was performed entirely at 25° C. The value for 1 It is the current value at which the battery capacity is discharged for one hour.

In this configuration, the non-aqueous electrolyte can also contain lithium difluorophosphate.

When the non-aqueous electrolyte contains lithium difluorophosphate (LiPO₂F₂), the low temperature output characteristics are increased.

When too little lithium difluorophosphate is added, the effect is insufficient. When too much lithium difluorophosphate is added, the upper limit on effectiveness is exceeded and the additional amount is not cost effective. Therefore, the amount of lithium difluorophosphate added is preferably from 0.01 to 0.10 mol/L.

The ranges for the amount of lithium bis(oxalato)borate and lithium difluorophosphate included in the non-aqueous electrolyte are determined based on the non-aqueous electrolyte in the non-aqueous electrolyte secondary battery after assembly and before the first charge. The ranges are determined in this manner because the amount gradually decreases as the non-aqueous electrolyte battery containing these compounds is charged.

The positive electrode active material used in the present invention is preferably a lithium-containing transition metal composite oxide because of their superior discharge characteristics. Also, the negative electrode active material used in the present invention is preferably a carbon material because of their superior discharge characteristics.

### Effect of the Invention

The present invention is able to provide a non-aqueous electrolyte secondary battery with high capacity and superior cycle characteristics without adversely affecting safety.

### BRIEF DESCRIPTION OF THE DRAWINGS

FIG. 1 is a perspective view of a non-aqueous electrolyte secondary battery according to the present invention.

FIG. 2 is a diagram showing the electrode assembly used in a non-aqueous electrolyte secondary battery according to the present invention.

FIG. 3a-3b are plan views showing the positive and negative electrodes used in a non-aqueous electrolyte secondary battery according to the first embodiment of the present invention.

### DETAILED DESCRIPTION

### Embodiment 1

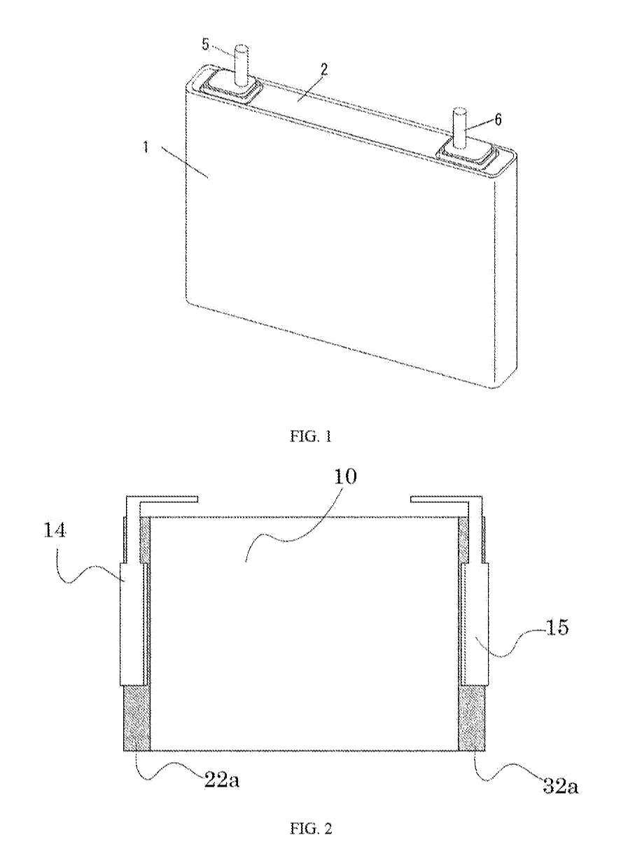

The following is an explanation with reference to the drawings of the battery of the present invention as applied to a lithium ion secondary battery. FIG. 1 is a perspective view of a non-aqueous electrolyte secondary battery according to the present invention,

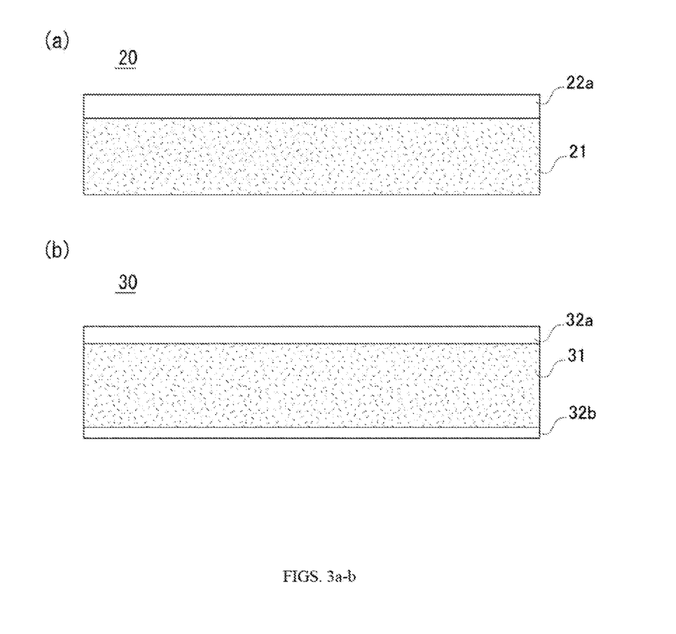

FIG. 2 is a diagram showing the electrode assembly used in a non-aqueous electrolyte secondary battery according to the present invention, and FIG. 3 is a plan view showing the positive and negative electrodes used in a non-aqueous electrolyte secondary battery according to the first embodiment of the present invention.

As shown in FIG. 1, a lithium ion secondary battery of the present invention has a rectangular outer can 1 with an opening, a sealing plate 2 for sealing the opening in the outer can 1, and positive and negative electrode terminals 5, 6 protruding outward from the sealing plate 2.

Also, as shown in FIG. 3, the positive electrode 20 in the electrode assembly has a positive electrode core exposing portion 22a exposed on at least one end in the longitudinal direction of the band-shaped positive electrode core, and a positive electrode active material layer 21 formed on the positive electrode core. The negative electrode 30 has a first negative core exposing portion 32a and a second negative electrode core exposing portion 32b exposed on both ends of the band-shaped negative electrode core in the longitudinal direction, and a negative electrode active material layer 31 formed on the negative electrode core.

In the electrode assembly 10, the positive electrode and the negative electrode are wound together via an interposed separator which is a microporous polyethylene membrane. As shown in FIG. 2, the positive electrode core exposing portion 22a protrudes from one end of the electrode assembly 10, the negative electrode core exposing portion 32a protrudes from the other end of the electrode assembly 10, the positive electrode collector 14 is mounted on the positive electrode core exposing portion 22a, and the negative electrode collector 15 is mounted on the negative electrode core exposing portion 32a.

This electrode assembly 10 is housed inside the outer can 1 along with the non-aqueous electrolyte, and the positive electrode collector 14 and the negative electrode collector 15 are connected electrically to external electrodes 5, 6 protruding from the sealing plate 2 while being insulated from the sealing plate 2 to extract current.

The non-aqueous electrolyte includes a non-aqueous solvent and an electrolyte salt dissolved in this solvent. The non-aqueous solvent includes 25 to 40 vol % ethylene carbonate at 25° C. and 1 atm, and the non-aqueous electrolyte includes lithium bis(oxalato)borate as an electrolyte salt. The ethylene carbonate improves the discharge characteristics, and the lithium bis(oxalato)borate improves the cycle characteristics. The amount of lithium bis(oxalato)borate added is preferably 0.06 to 0.18 mol/L.

Lithium difluorophosphate may be added to the non-aqueous electrolyte to improve the low temperature output characteristics. The amount of lithium difluorophosphate added is preferably 0.01 to 0.10 mol/L.

Also, the amount of positive electrode active material in the positive electrode active material layer is equal to or greater than 100 g, the amount of negative electrode active material in the negative electrode active material layer is equal to or greater than 50 g, and the battery capacity of the non-aqueous electrolyte secondary battery is equal to or greater than 15 Ah.

A non-aqueous electrolyte containing lithium bis(oxalato)borate readily reacts with the negative electrode and generates heat under high-temperature charging conditions. The generated heat tends to increase as the amount of ethylene carbonate in the non-aqueous electrolyte and the amount of positive electrode active material rise. In a high-capacity battery, in which the amount of positive electrode active material is 100 g or more, the amount of negative electrode active material is 50 g or more and the battery capacity is 15 Ah or more, the amount of ethylene carbonate is kept to 40 vol % or less in order to reduce the amount of heat generated by the non-aqueous electrolyte containing lithium bis(oxalato)borate without adversely affecting safety.

The following is an explanation of the method used to manufacture a lithium ion secondary battery with this configuration.

### Preparation of Positive Electrode

The positive electrode active material slurry is prepared by mixing together a lithium-containing nickel-cobalt-manganese composite oxide (LiNi_{0.35}Co_{0.35}Mn_{0.3}O₂) serving as the positive electrode active material, a carbon-based charging agent such as acetylene black or graphite, and a binder such as polyvinylidene fluoride (PVDF) at a mass ratio of 88:9:3, and then dissolving and mixing the mixture in N-methyl-2-pyrrolidone serving as the organic solvent.

The positive electrode active material slurry is applied to a uniform thickness on both sides of band-shaped aluminum foil serving as the positive electrode core 22 (thickness: 15 μm) using a die coater or doctoring blade. However, the slurry is not applied on the ends in the longitudinal direction of the positive electrode core 22 (the end in the same direction on both sides) to expose the core and form the positive electrode core exposing portion 22a.

The electrode is passed through a dryer to remove the organic solvent and create a dry electrode. The dry electrode is then rolled using a roll press. Afterwards, it is cut to a predetermined size to complete the positive electrode 20.

### Preparation of Negative Electrode

The negative electrode active material slurry is prepared by mixing together graphite serving as the negative electrode active material, styrene butadiene rubber serving as the binder, and carboxymethyl cellulose serving as the thickener at a mass ratio of 98:1:1, and then adding the appropriate amount of water.

The negative electrode active material slurry is applied to a uniform thickness on both sides of band-shaped copper foil serving as the negative electrode core 32 (thickness: 10 μm) using a die coater or doctoring blade. However, the slurry is not applied on the ends in the longitudinal direction of the negative electrode core 32 to expose the core and form the negative electrode core exposing portions 32a, 32b.

The electrode is passed through a dryer to remove the water and create a dry electrode. The dry electrode is then rolled using a roll press. Afterwards, it is cut to a predetermined size to complete the negative electrode 30.

### Preparation of Electrode Assembly

As shown in FIG. 3, the positive electrode, the negative electrode and a polyethylene microporous membrane separator were laid on top of each other so that the positive electrode core exposing portion 22a and the negative electrode core exposing portion 32a protruded from the three layers in opposite directions relative to the winding direction, and so that the separator was interposed between the different active material layers. The layers were then wound together using a winding machine, insulated tape was applied to prevent unwinding, and the resulting electrode assembly was flattened using a press.

### Connection of Collector Plate to Sealing Plate

An aluminum positive electrode collector 14 and a copper negative electrode collector 15 with two protrusions (not shown) on the same surface were prepared, and two aluminum positive electrode collector receiving components (not shown) and two copper negative electrode collector receiving components (not shown) with one protrusion on one surface were also prepared. Insulating tape was applied to enclose the protrusions of the positive electrode collector 14, negative electrode collector 15, positive electrode collector receiving components and negative electrode collector receiving components.

A gasket (not shown) was arranged on the inside surface of a through-hole (not shown) provided in the sealing plate 2, and on the outside surface of the battery surrounding the through-hole, and an insulating component (not shown) was arranged on the inside surface of the battery surrounding the through-hole provided in the sealing plate 2. The positive electrode collector 14 was positioned on top of the insulating component on the inside surface of the sealing plate 2 so that the through-hole in the sealing plate 2 was aligned with the through-hole (not shown) in the collector plate. Afterwards, the inserted portion of a negative electrode terminal 5 having a flange portion (not shown) and an inserted portion (not shown) was inserted from outside the battery into the through-hole in the sealing plate 2 and the through-hole of the collector plate. The diameter of the lower end of the inserted portion (inside the battery) is then widened, and the positive electrode collector 14 and the positive electrode terminal 5 were caulked to the sealing plate 2.

The negative electrode collector 15 and the negative electrode terminal 6 were caulked to the sealing plate 2 in the same way on the negative electrode side. In this operation, the various components were integrated, and the positive and negative electrode collectors 14, 15 and the positive and negative electrode terminals 5, 6 were connected conductively. In this structure, the positive and negative electrode terminals 5, 6 protruded from the sealing plate 2 while remaining insulated from the sealing plate 2.

### Mounting of Collector

The positive electrode collector 14 was arranged on the side of the flat electrode assembly with the core exposing portion of the positive electrode 11 so that the protrusion was on the side with the positive electrode core exposing portion 22a. One of the positive electrode collector receiving components is brought into contact with the positive electrode core exposing portion 22a so that the protrusion on the positive electrode collector receiving component is on the positive electrode core exposing portion 22a side, and so that one of the protrusions on the positive electrode collector 14 is facing the protrusion on the positive electrode collector receiving component. Next, a pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded to the positive electrode core exposing portion 22a.

Afterwards, the other positive electrode collector receiving portion is brought into contact with the positive electrode core exposing portion 22a so that the protrusion on the positive electrode collector receiving portion is on the positive electrode core exposing portion 22a side, and so that the other protrusion on the positive electrode collector 14 is facing the protrusion on the positive electrode collector receiving component. Next, the pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded a second time to the positive electrode core exposing portion 22a.

In the case of the negative electrode 12, the negative electrode collector 15 and the negative electrode collector receiving components are resistance-welded to the first negative electrode core exposing portion 32a in the same way.

### Preparation of Non-Aqueous Electrolyte

Ethylene carbonate (EC) and ethyl methyl carbonate (EMC) are mixed together at a volume ratio of 3:7 (1 atm, 25° C.), and a LiPF₆ electrolyte salt is dissolved in the resulting non-aqueous solvent at a ratio of 1.0 M (mol/L) to complete the base electrolyte. To the resulting base electrolyte solution are added 0.3 mass % vinylene carbonate, 0.1 mol/L lithium bis(oxalato)borate (LiB(C₂O₄)₂), and 0.05 mol/L lithium difluorophosphate (LiPO₂F₂). The result is the non-aqueous electrolyte.

### Assembly of Battery

The electrode assembly 10 integrated with the sealing plate 2 was inserted into the outer can 1, the sealing plate 2 was fitted into the opening in the outer can 1, the welded portion of the outer can 1 was laser-welded around the sealing plate 2, a predetermined amount of non-aqueous electrolyte was poured in via a non-aqueous electrolyte hole (not shown) in the sealing plate 2, and the non-aqueous electrolyte hole was sealed.

### Preliminary Testing

A non-aqueous electrolyte (non-aqueous electrolyte A) was prepared in the same manner as the embodiment, and another non-aqueous electrolyte (non-aqueous electrolyte B) was prepared in the same manner except the ethylene carbonate (EC) and the ethyl methyl carbonate (EMC) were mixed together at a volume ratio of 2.5:7.5 (when converted to 25° C. and 1 atm).

A non-aqueous electrolyte secondary battery was assembled in the same manner as the embodiment. The battery was charged at a constant current of 25 A to a voltage of 4.1 V, and then charged for 1.5 hours at a constant voltage of 4.1 V. The battery was decomposed in a dry box, and the negative electrode was rinsed in dimethyl carbonate and vacuum-dried. The negative electrode materials (negative electrode active material+thickener+binder) were then extracted from the negative electrode.

Next, 2.5 mg of the extracted negative electrode materials and 5.0 mg of non-aqueous electrolyte A or non-aqueous electrolyte B were sealed inside a SUS cell in an argon atmosphere, the temperature was raised 5° C. per minute, and the amount of heat generated was measured using a differential scanning calorimeter (DSC).

As a result, the example using non-aqueous electrolyte B containing 25 vol % ethylene carbonate generated 3% less heat than non-aqueous electrolyte A containing 30 vol % ethylene carbonate.

It is clear from the results that less heat is generated when the non-aqueous electrolyte contains less ethylene carbonate.

### EXAMPLE 1

The non-aqueous electrolyte secondary battery in the first example was assembled in the same manner as the embodiment. The amount of positive electrode active material contained in the battery was 190 g, and the amount of negative electrode active material was 94 g.

### Comparative Example 1

The non-aqueous electrolyte secondary battery in the first comparative example was assembled in the same manner as the first example except the ethylene carbonate (EC) and the ethyl methyl carbonate (EMC) were mixed together at a volume ratio of 2:8 (when converted to 25° C. and 1 atm).

### Cycle Test

The batteries in the first example and the first comparative example were charged and discharged under the following conditions, and the capacity retention rate and the output retention rate were calculated using the equation below. The batteries were charged to a state of charge of 50% at a 25° C. and a charging current of 25 A, and then discharged for 10 seconds at currents of 40 A, 80 A, 120 A, 160 A, 200 A and 240 A. The battery voltage was measured at each current, each current value and battery voltage was plotted, and the output was calculated from the I-V characteristics during the discharge. The state of charge displaced by the discharge was then returned to the original state of charge by charging the battery at a constant current of 25 A. The charging and discharging were performed at 1 atm and 25° C. The results are shown in Table 1.

Charge: To voltage of 4.1 V at constant current of 1 It (25 A), then 1.5 hours at constant voltage of 4.1V.

Discharge: To voltage 2.5 V at constant current of 1 It (25 A).

Capacity Retention Rate (%)=discharge capacity in 400th cycle÷discharge capacity in 1st cycle×100.

Output Retention Rate (%)=output after 400th cycle÷output at initial discharge×100.

### Nail Puncture Test

The batteries in the first example and the first comparative example were charged to a voltage of 4.1 V at a constant current of 1 It (25 A), and then charged for two hours at a constant voltage of 4.1 V. Afterwards, the central portion of the batteries were punctured at a rate of 80 mm/seconds using a nail with a diameter of 3 mm and a length of 5.5 cm to determine whether or not the batteries would rupture or ignite. The results are shown in Table 1.

TABLE 1

| | | Battery | Capacity | Output | |
|---|---|---|---|---|---|
| | EC Ratio | Capacity | Retention | Retention | |
| | (%) | (Ah) | (%) | (%) | Safety |
| Example 1 | 30 | 25.0 | 95 | 97 | Good |
| Comparative | 20 | 25.0 | 80 | 71 | Good |
| Example 1 | | | | | |

It is clear from Table 1 that the capacity retention rate (95%) and the output retention rate (97%) of the first example containing 30 vol % EC were better than the capacity retention rate (80%) and the output retention rate (71%) of the first comparative example containing 20 vol % EC.

The following is believed to be the reason why. Discharge characteristics such as the post-cycle capacity retention rate and output retention rate increase as the amount of ethylene carbonate contained in the non-aqueous solvent rises. Because the effect from the ethylene carbonate is insufficient when the amount of ethylene carbonate contained in the non-aqueous solvent is 20 vol % or less, the capacity retention rate and output retention rate of the first comparative example were inadequate. The amount of ethylene carbonate contained in the non-aqueous solvent is preferably 25 vol % or more.

The heat generated by a reaction with the negative electrode increases and safety decreases when the amount of ethylene carbonate contained in the non-aqueous solvent rises. When the amount of ethylene carbonate contained in the non-aqueous solvent is greater than 40 vol %, the amount of heat generated is too great. Because the amount of ethylene carbonate in both the first example and the first comparative example is less than 30 vol %, the results of the safety test are good (no rupture or combustion).

### Additional Details

The positive electrode active material can be one or more of the following: a lithium-containing nickel-cobalt-manganese composite oxide (LiNiₓCo_{y}Mn_{z}O₂, x+y+z=1, 0≦x≦1, 0≦y≦1, 0≦z≦1), a lithium-containing cobalt composite oxide (LiCoO₂), lithium-containing nickel composite oxide (LiNiO₂), a lithium-containing nickel-cobalt composite oxide (LiCoₓNi₁₋ₓO₂), a lithium-containing manganese composite oxide (LiMnO₂), spinel-type lithium manganese oxide (LiMn₂O₄), or a lithium-containing transition metal composite oxide in which some of the transition metal in the oxide has been substituted by another element (for example, Ti, Zr, Mg, Al, etc.).

The negative electrode active material can be a carbon material such as natural graphite, carbon black, coke, glassy carbon, carbon fibers, or baked products of these. These carbon materials can be used alone or in mixtures of two or more.

The non-aqueous solvent can be one or more of the following: a high dielectric constant solvent in which lithium salts are highly soluble including a cyclic carbonate, such as ethylene carbonate, propylene carbonate, butylene carbonate or fluoroethylene carbonate, or a lactone such as γ-butyrolactone or γ-valerolactone; a linear carbonate, such as diethyl carbonate, dimethyl carbonate or ethyl methyl carbonate; or a low viscosity solvent including an ether, such as tetrahydrofuran, 1,2-dimethoxyethane, diethylene glycol dimethylethane, 1,3-dioxolane, 2-methoxytetrahydrofuran or diethyl ether; or a carboxylic acid ester, such as ethyl acetate, propyl acetate or ethyl propionate. A mixed solvent including two or more types of high dielectric constant solvent and low viscosity solvent can also be used.

In addition to lithium bis(oxalato)borate (LiB(C₂O₄)₂), one or more other lithium salts (base electrolyte salts) can be used as electrolyte salts. Examples include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F5SO₂)₃, LiAsF₆, LiClO₄, Li₂B₁₀Cl₁₀, Li₂B₁₂Cl₁₂, LiB(C₂O₄)F₂, LiP(C₂O₄)₃, LiP(C₂O₄)₂F₂, and LiP(C₂O₄)F₄. The total concentration of electrolyte salts in the non-aqueous electrolyte is preferably from 0.5 to 2.0 M (mol/L).

Any well-known additive, such as vinylene carbonate, cyclohexyl benzene, and tert-amyl benzene can be added to the non-aqueous electrolyte.

A microporous membrane or membrane laminate of an olefin resin, such as polyethylene, polypropylene or a mixture thereof, can be used as the separator.

### INDUSTRIAL APPLICABILITY

As explained above, the present invention can provide with high productivity a high-capacity non-aqueous electrolyte secondary battery. Thus, industrial applicability is great.

### KEY TO THE DRAWINGS

1: Outer Can

2: Sealing Plate

5, 6: Electrode Terminals

10: Electrode Assembly

14: Positive Electrode Collector

15: Negative Electrode Collector

20: Positive Electrode

21: Positive Electrode Active Material Layer

22a: Positive Electrode Core Exposing Portion

30: Negative Electrode

31: Negative Electrode Active Material Layer

32a, 32b: Negative Electrode Core Exposing Portions

What is claimed is:

1. A non-aqueous electrolyte secondary battery including a positive electrode, a negative electrode and a non-aqueous electrolyte containing a non-aqueous solvent, the non-aqueous electrolyte secondary battery characterized in that the positive electrode has a positive electrode core and a positive electrode active material layer formed on the positive electrode core, the negative electrode has a negative electrode core and a negative electrode active material layer formed on the negative electrode core, the non-aqueous solvent includes 25 to 40 vol % ethylene carbonate at 25° C. and 1 atm, the non-aqueous electrolyte includes lithium bis(oxalato)borate, the amount of positive electrode active material in the positive electrode active material layer is equal to or greater than 100 g, the amount of negative electrode active material in the negative electrode active material layer is equal to or greater than 50 g, and the battery capacity of the non-aqueous electrolyte secondary battery is equal to or greater than 15 Ah.

2. The non-aqueous electrolyte secondary battery according to claim 1, wherein the non-aqueous electrolyte also includes lithium difluorophosphate.

3. The non-aqueous electrolyte secondary battery according to claim 1, wherein the positive electrode active material is a lithium-containing transition metal composite oxide, and the negative electrode active material is a carbon material.
